(19) United States
(12) Patent Application Publication
(10) Pub. No.: US 2008/0156771 A1
(43) Pub. Date: Jul. 3, 2008

(54) ETCHING APPARATUS USING NEUTRAL BEAM AND METHOD THEREOF

(75) Inventors: Yun Kwang JEON, Seoul (KR); Jin Seok Lee, Seoul (KR); Yung Hee Lee, Seoul (KR); Gi Tae Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/965,956

(22) Filed: Dec. 28, 2007

(30) Foreign Application Priority Data
Jan. 3, 2007 (KR) 2007-000674

(51) Int. Cl. C23F 1/00; B44C 1/22

(52) U.S. Cl. 216/66; 156/345.51; 156/345.43

(57) ABSTRACT

An etching apparatus using a neutral beam includes an electron emission unit to convert an ion beam, extracted from plasma by a plurality of grids, into a neutral beam by colliding the ion beam with electrons to prevent the ion beam from physically colliding with the electron emission unit, thus preventing the damage to a neutralization unit and generation of foreign substances with a simple structure. Further, the etching apparatus converts the ion beam into the neutral beam at a high neutralizing efficiency without causing directionality and energy losses, and generates a neutral beam having a large area, thus uniformly etching a semiconductor wafer.

### CROSS-REFERENCE TO RELATED APPLICATIONS

This application priority under 35 U.S.C. § 119(a) from Korean Patent Application No. 2007-0000674, filed Jan. 3, 2007, in the Korean Intellectual Property Office, the disclosure of which is incorporated herein in its entirety by reference.

### BACKGROUND OF THE INVENTION

1. Field of the Invention

The present general inventive concept relates to an etching apparatus using a neutral beam, and more particularly, to an etching apparatus using a neutral beam, which etches a target object, such as a semiconductor wafer, by converting an ion beam extracted from plasma into a neutral beam, and a method thereof.

2. Description of the Related Art

As integration of semiconductor devices has increased in demand, design of smaller semiconductor integrated circuits has resulted in the production of semiconductor integrated circuits with a critical dimension of less than 0.25 μm. In order to design the above microscopic semiconductor devices, ion-reinforced etching apparatuses, such as a high density plasma etcher and a reactive ion etcher, are mainly used.

A large amount of ions are used for performing an etching process in the above etching apparatuses. The ions collide with a semiconductor wafer, or a specific material layer on the semiconductor wafer, with energy of several hundreds of eV, thus causing physical and electrical damage to the semiconductor wafer or the specific material layer. Accordingly, an etching apparatus using a neutral beam, which minimizes the damage to a material layer to be etched, while precisely controlling an etching depth, has been researched.

As illustrated in FIG. 1, an etching apparatus using a neutral beam includes a chamber unit 1, which is divided into a source chamber located at the upper part thereof and a process chamber located at the lower part thereof by reflection plates 4 such that the source and process chambers communicate with each other. Gas supply units 2 for supplying a reaction gas for performing an etching process to the inside of the source chamber are formed at side surfaces of the source chamber, and three grids 3 for extracting an ion beam from plasma generated in the source chamber are provided in the source chamber. The reflection plates 4 serving as a neutralization unit for converting the ion beam extracted by the three grids 3 into a neutral beam and a chuck 6 for fixing and supporting a semiconductor wafer 5, which is etched by the neutral beam converted by the reflection plates 4, are provided in the process chamber, and a gas exhaust port 7 for expelling a gas in the process chamber is formed through one surface of the process chamber. A high-frequency power source unit 8a and 8b for converting the reaction gas supplied by the gas supply units 2 into the plasma, and a DC power source unit 9 for respectively supplying DC powers having different polarities and sizes to the three grids 3 are provided.

Now, the operation of the above etching apparatus will be described.

The reaction gas supplied to the source chamber is converted into plasma by the high-frequency power source unit 8a and 8b, and an ion beam having a designated polarity is extracted from the plasma by the three grids 3. When the extracted ion beam collides with the reflection plates 4, which are electrically grounded, the ion beam is converted into a neutral beam having non electrical characteristic due to the electrical ion exchange with the reflection plates 4, and the neutral beam is reflected at the same angle as an incident angle to etch the surface of the semiconductor wafer 5.

However, the above conventional etching apparatus has several problems, such as the reduced life span of the reflection plates 4 due to the physical collision with the ion beam extracted from the plasma, the generation of foreign substances due to the collision, and the generation of energy and directionality losses due to neutralization.

### SUMMARY OF THE INVENTION

The general inventive concept provides an etching apparatus using a neutral beam, in which an ion beam extracted from plasma is converted into a neutral beam without physically colliding with a neutralization unit to prevent damage to the neutralization unit and generation of foreign substances due to a collision, thus having a high neutralizing efficiency and not causing directionality and energy losses.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an etching apparatus using a neutral beam, which extracts an ion beam from plasma generated in a chamber unit, converts the ion beam into a neutral beam, and etches a target object using the neutral beam, including an ion extraction unit to extract the ion beam from the plasma generated in the chamber unit, an electron emission unit to convert the extracted ion beam into the neutral beam by a collision of the ion beam with electrons, and a chuck to fix and support the target object to be etched by the neutral beam.

The foregoing and/or other aspects and utilities of the present general inventive concept are achieved by providing an etching apparatus using a neutral beam, which extracts an ion beam from plasma generated in a chamber unit, converts the ion beam into a neutral beam, and etches a target object using the neutral beam, including a plurality of first electrodes to extract the ion beam from the plasma generated in the chamber unit, a second electrode, the surface of which is coated with an electron emission layer, to convert the extracted ion beam into the neutral beam by a collision of the ion beam with electrons, a third electrode provided between the plurality of first electrodes and the second electrode to control an emission amount of the electrons; and a chuck to fix and support the target object to be etched by the neutral beam.

The foregoing and/or other aspects and utilities of the present general inventive concept are achieved by providing an etching apparatus divided into a source chamber and a process chamber to etch a target object using an ion beam from plasma generated in source chamber, including a grid of ion extraction electrodes to extract the ion beam and to control characteristics of the ion beam, and an electron emission electrode to divide the source chamber and the process chamber to convert the ion beam extracted by the grid of ion extraction electrodes into a neutral beam, and including a plurality of through holes.

The grid of ion extraction electrodes may include a first row of electrodes to extract and accelerate an ion beam, a second row of electrodes to decelerate the ion beam, and a third row of electrodes to concentrate the ion beam.

The electrodes may be disposed in an ion extraction direction.

Each of the electrodes on each of the first row, second row, and third row, may include a plurality of coinciding through holes.

Pressures in the source chamber and the process chamber may vary according to sizes of the through holes of the grid and sizes of the through holes of the electron emission electrode.

The electron emission electrode my emit electrons such that the electrons collide with the ion beam extracted by the grid of ion extraction electrodes to convert the ion beam into a neutral beam.

The electron emission electrode may emit electrons to the traveling ion beam such that the electrons uniformly collide with the ion beam.

The electron emission electrode may be a cool cathode, which can emit electrons with a small voltage without increasing in temperature.

The electron emission electrode may be disposed in parallel with the grid of ion extraction electrodes.

The electron emission electrode may include an electron emission layer to facilitate emission of electrons.

The foregoing and/or other aspects and utilities of the present general inventive concept are achieved by providing a method of etching apparatus a target object using a neutral beam, which extracts an ion beam from plasma generated in a chamber unit, converts the ion beam into a neutral beam, and etches the target object using the neutral beam, the method including extracting the ion beam from the plasma generated in the chamber unit, converting the extracted ion beam into the neutral beam by a collision of the ion beam with electrons, and fixing and supporting the target object to be etched by the neutral beam.

The foregoing and/or other aspects and utilities of the present general inventive concept are achieved by providing a method of etching apparatus a target object using a neutral beam, which extracts an ion beam from plasma generated in a chamber unit, converts the ion beam into a neutral beam, and etches the target object using the neutral beam, the method including extracting the ion beam from the plasma generated in the chamber unit, converting the extracted ion beam into the neutral beam by a collision of the ion beam with electrons, controlling an emission amount of the electrons, and fixing and supporting the target object to be etched by the neutral beam.

The foregoing and/or other aspects and utilities of the present general inventive concept are achieved by providing a method of an etching a target object using an ion beam from plasma generated in source chamber object apparatus, wherein the apparatus is divided into a source chamber and a process, the method including extracting the ion beam, controlling characteristics of the ion beam, and converting the extracted ion beam into a neutral beam by emitting electrons such that the electrons collide with the ion beam.

### BRIEF DESCRIPTION OF THE DRAWINGS

These and/or other aspects and utilities of the present general inventive concept will become apparent and more readily appreciated from the following description of the embodiments, taken in conjunction with the accompanying drawings in which:

FIG. 1 is a schematic sectional view of a conventional etching apparatus using a neutral beam;

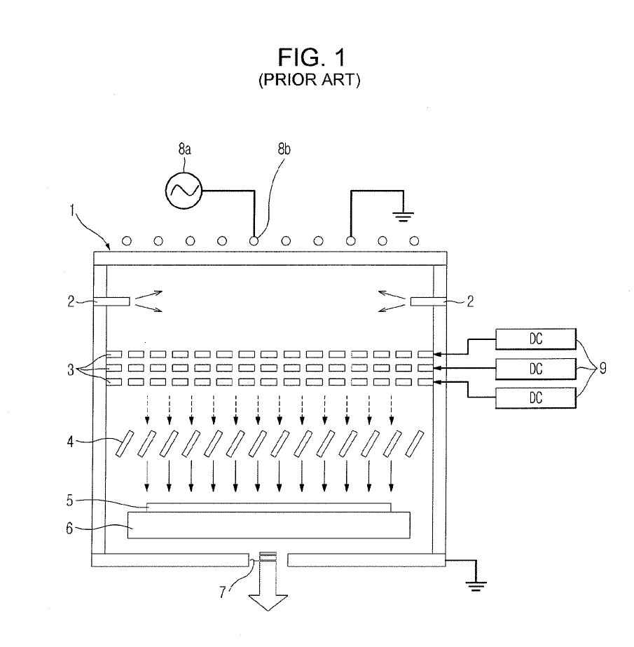

FIG. 2 is a schematic sectional view of an etching apparatus using a neutral beam in accordance with an embodiment of the present general inventive concept;

FIG. 3A is a view illustrating an example of shapes of through holes formed through each of a plurality of grids of FIG. 2;

FIG. 3B is a view illustrating another example of shapes of through holes formed through each of a plurality of grids of FIG. 2; and

FIG. 4 is a schematic sectional view of an etching apparatus using a neutral beam in accordance with another embodiment of the present general inventive concept.

### DETAILED DESCRIPTION OF THE PREFERRED EMBODIMENTS

Reference will now be made in detail to the embodiments of the present general inventive concept, an example of which is illustrated in the accompanying drawings, wherein like reference numerals refer to like elements throughout. The embodiments are described below to explain the present general inventive concept by referring to the annexed drawings.

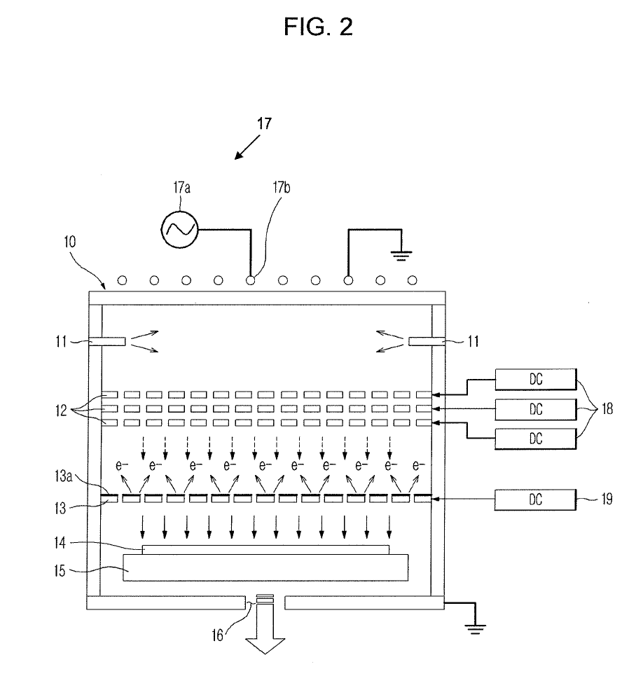

As illustrated in FIG. 2, an etching apparatus using a neutral beam in accordance with an embodiment of the present general inventive concept includes a chamber unit 10 divided into a source chamber and a process chamber, gas supply units 11, an ion extraction unit having a plurality of grids 12 and a first DC power source unit 18, an electron emission unit having electron emission electrode 13, an electron emission layer 13a and a second DC power source unit 19, a chuck 15, and a gas exhaust port 16, and a high-frequency power source unit 17.

The chamber unit 10 is divided into the source chamber which is located at an upper part thereof, and the process chamber which is located at a lower part thereof, by the electron emission electrode 13.

The source chamber is provided above the process chamber such that the source chamber can communicate with the process chamber.

The gas supply units 11 to supply a reaction gas to perform an etching process are connected to both side surfaces of the source chamber. N2, H2, Ar, NF3, and O2 can be used as the reaction gas. One or combinations of at least two selected from the group consisting of N2, H2, Ar, NF3, and O2 may be used as the reaction gas. That is, different substances can be used as the reaction gas according to target materials to be etched. Further, a supply amount and a supply time of the reaction gas may vary.

The high-frequency power source unit is provided at the outside of the upper part of the source chamber. The high-frequency power source unit includes a high-frequency coil 17b which is disposed along the outer surface of the upper part of the source chamber, and a high-frequency power unit 17a connected to the high-frequency coil 17b. The reaction gas which is supplied to the source chamber is primarily exposed to high-frequency power. A high-frequency electric field is formed in the source chamber by the high-frequency power source unit, and the reaction gas is converted into plasma by the high-frequency electric field. When heat is applied to a material in a gas state, the material is converted into a plasma state, i.e., the fourth state, in which atoms of the material are divided into electrons and positive ions. This state is usually referred to as “plasma”. The plasma is a state in which charged particles and neutral particles of the material are gathered. Specifically, a density of negatively-charged particles and a density of positively-charged particles of the material are approximately the same, thus generally exhibiting neutrality. Accordingly, the charged particles include electrons and ions, and the neutral particles include radicals. The plasma flows downstream, thus generating a downward flow from the source chamber to the process chamber.

The plurality of grids 12 include, for example, three grids to extract an ion beam having a designated polarity from the plasma which are installed in the source chamber. Each of the grids 12 has a similar cross section to an internal cross section of the source chamber. The grids 12 are horizontally disposed above the chuck 15, on which a semiconductor wafer 14 is mounted. The grids 12 are made of a conductive metal, and have polarities by DC powers having the different polarities and sizes supplied from the DC power source unit 18, thus forming an electric field. One or a plurality of grids may be installed.

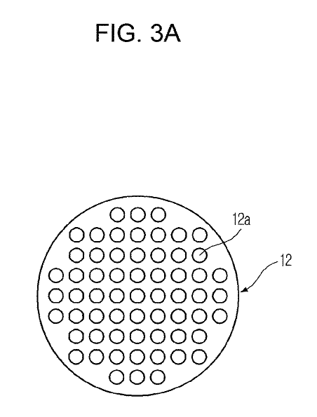

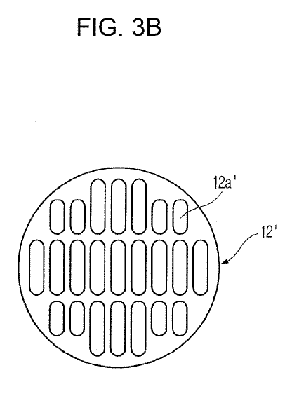

Each of the plurality of grids 12 includes an ion extraction electrode, which is electrically insulated, and the ion extraction electrodes of the grids 12 are spaced from each other by regular intervals. The ion extraction electrodes can control characteristics, such as energy of the ion beam. For example, when each of the three grids 12 includes one ion extraction electrode, the first electrode can extract and accelerate an ion beam, the second electrode can decelerate the ion beam, and the third electrode can concentrate the ion beam. The electrodes are disposed in an ion extraction direction. In order to simultaneously hold the plasma and extract the ion beam, a plurality of through holes are formed through each of the electrodes. As illustrated in FIGS. 3A and 3B, small circular holes 12a and slits 12a′, respectively, having a size to prevent the plasma from leaking therethrough are formed. The through holes formed through the electrodes are arranged so as to correspond to each other.

The source chamber and the process chamber are divided from each other by the electron emission electrode 13 to convert the ion beam extracted by the grids 12 into a neutral beam. The internal cross section of the source chamber may be smaller than the internal cross section of the process chamber. Further, a pressure gradient between the two chambers may exist. Pressures of the two chambers vary according to sizes of the through holes of the grids 12 and sizes of through holes of the electron emission electrode 13. The pressure of the source chamber may be at least twice the pressure of the process chamber. The electron emission electrode 13 emits electrons such that the electrons collide with the ion beam extracted by the grids 12, to convert the ion beam into a neutral beam. The electron emission electrode 13 can be disposed in parallel with the grids 12, and includes a plate provided with a plurality of through holes. An electron emission layer 13a (for example, carbon nano-tube (CNT) layer) to facilitate emission of electrons is applied to the surface of the electron emission electrode 13. Power, which is applied to the electron emission electrode 13 by the second DC power source unit 19, designates the electron emission electrode 13 as a cathode in consideration of an electric potential difference between the last electrode of the ion extraction electrodes, which becomes an anode, and the extracted ion beam. Before the ion beam can pass through the electron emission electrode 13, the ion beam is converted into a neutral beam.

The electron emission electrode 13 emits electrons to the traveling ion beam such that the electrons uniformly collide with the ion beam. The electron emission electrode 13 is a cool cathode, which can emit electrons with a small voltage without increasing in temperature. Accordingly, an anode is required to emit the electrons. The last electrode to extract ions is designated as the anode. Further, when the last electrode has an electric potential lower than that of the extracted ion beam, the ion beam is designated as another anode. The through holes of the electron emission electrode 13 can have a diameter equal to or larger than that of the through holes of the grids 12. That is, after the extracted ion beam is converted into the neutral beam, the neutral beam must be incident upon the semiconductor wafer 14 without reducing flux.

A last electrode of the ion extraction electrodes can be designated as an anode and the electron emission electrode 13 can be designated as a cool cathode which easily emits electrons, and electrons can be emitted from the electron emission electrode 13 due to an electric potential difference between the two electrodes. The emitted electrons travel in the direction of the ion beam incident upon the electron emission electrode 13. At this time, the ion beam can be designated as another anode. Then, the ion beam is converted into a neutral beam by colliding with the electrons, and the neutral beam passes through the electron emission electrode 13 and is incident upon the semiconductor wafer 14.

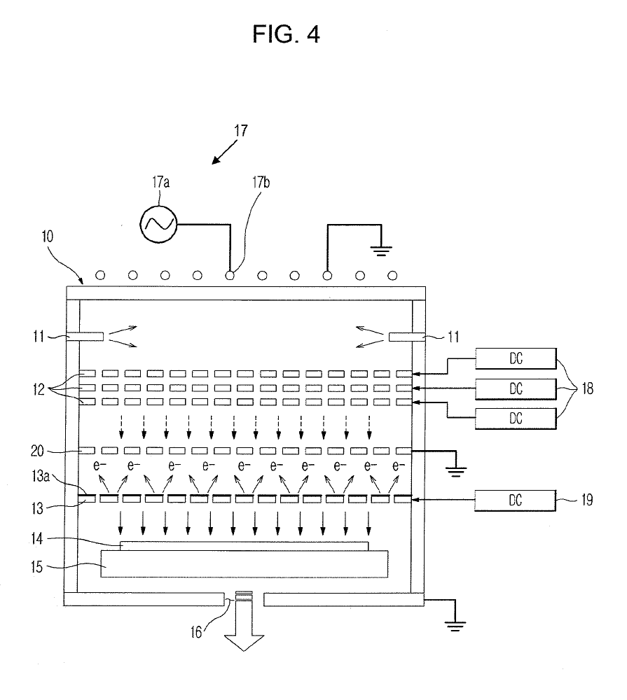

Further, as illustrated in FIG. 4, an etching apparatus using a neutral beam in accordance with another embodiment of the present general inventive concept further includes an anode 20, which is installed between grids 12 and an electron emission electrode 13, has the same shape as that of ion extraction electrodes of the grids 12, and emits electrons, instead of the last electrode of the ion extraction electrodes. That is, the etching apparatus may have a structure in which an ion beam extraction unit and an electron emission unit are separated from each other. When ions having directionality travel and pass through a section in which electrons are emitted and accelerated, an ion beam can collide with the electrons, thus being converted into a neutral beam.

A chuck 15 to support a semiconductor wafer 14 is disposed at the central portion of the inside of the process chamber. The chuck 15 fixes and supports the semiconductor wafer 14 at a designated height from the bottom of the process chamber.

A gas exhaust port 16 is formed through a designated portion of the process chamber. The gas exhaust port 16 expels a gas in the chamber unit 10, for example, a product generated by a reaction or a non-reacted gas, before and after an etching process.

Referring to FIGS. 2 through 4, a process to etch a semiconductor wafer using the above etching apparatus in accordance with the present general inventive concept will be described.

First, the inside of the chamber unit 10 is turned into a vacuum to perform the etching process. The inside of the chamber unit 10 is turned into a vacuum by expelling a gas in the chamber unit 10 to outside the chamber unit 10 through the gas exhaust port 16.

The semiconductor wafer 14 is supplied to the inside of the process chamber, and is mounted on the upper surface of the chuck 15.

Under the above state, a reaction gas to perform the etching process is supplied to the source chamber through the gas supply units 11. The reaction gas to perform the etching process is supplied from the gas supply units 11 to the source chamber by a downstream method. The reaction gas is converted into plasma in the source chamber. The high-frequency power unit 17a of the high-frequency power source unit supplies high-frequency power to the high-frequency coil 17b, thus converting the reaction gas in the source chamber into the plasma. Accordingly, the plasma is intensively generated in the source chamber. The plasma generated in the source chamber includes ions, electrons, and radicals.

The plasma is supplied from the source chamber to the process chamber by a downward air current. Here, when DC power is applied to the grids 12 through the first DC power source unit 18, as illustrated by the dotted arrows in FIG. 2, an ion beam including ions, having a designated polarity, and having a designated directionality is extracted from the plasma and accelerated by an electric field.

Further, when DC power is applied to the electron emission electrode 13 through the second DC power source unit 19, the electron emission layer 13a emits electrons due to an electric potential difference between the last electrode of the ion extraction electrodes, which is designated as an anode, and the electron emission electrode 13, which is designated as a cathode. The electrons, which are emitted in the direction of the ion beam which is incident upon the electron emission electrode 13, collide with the ion beam, thus converting the ion beam into a neutral beam. The neutral beam passes through the electron emission electrode 13, and is incident upon the semiconductor wafer 14, thus etching the surface of the semiconductor wafer 14, as illustrated by the solid arrows in FIG. 2.

As apparent from the above description, the present general inventive concept provides an etching apparatus using a neutral beam, which includes an electron emission unit to convert an ion beam, extracted from plasma by a plurality of grids, into a neutral beam by colliding with electrons to prevent the ion beam from physically colliding with the electron emission unit, thus preventing the damage to a neutralization unit and generation of foreign substances with a simple structure.

The etching apparatus of the present general inventive concept also can convert the ion beam into the neutral beam at a high neutralizing efficiency without causing directionality and energy losses.

The etching apparatus of the present general inventive concept causes the electron emission unit to emit the electrons throughout an ion beam extraction region in a direction opposite to a traveling direction of an ion beam, thus increasing a neutralizing efficiency and thus generating a neutral beam having a large area.

Although embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An etching apparatus to etch a target object in a chamber unit, comprising:
an ion extraction unit to extract an ion beam from plasma generated in the chamber unit;
an electron emission unit to convert the extracted ion beam into a neutral beam by a collision of the ion beam with electrons; and
a chuck to fix and support a target object to be etched by the neutral beam.

2. The etching apparatus according to claim 1, wherein the ion extraction unit comprises a plurality of ion extraction electrodes, each having plural through holes, and a first DC power source unit to respectively apply DC power to the plurality of ion extraction electrodes.

3. The etching apparatus according to claim 2, wherein the electron emission unit comprises an electron emission electrode having a surface coated with an electron emission layer, having plural through holes formed thereon, and a second DC power source unit to apply DC power to the electron emission electrode.

4. The etching apparatus according to claim 3, wherein the electron emission layer comprises a carbon nano-tube layer.

5. The etching apparatus according to claim 3, wherein the electrons are emitted according to an electric potential difference between a last electrode out of the plurality of ion extraction electrodes, to which the DC power is applied by the first DC power source unit, and the electron emission electrode, to which the DC power is applied by the second DC power source unit.

6. The etching apparatus according to claim 3, wherein a diameter of the through holes formed through the electron emission electrode is equal to or larger than a diameter of the through holes formed through the plurality of ion extraction electrodes.

7. The etching apparatus according to claim 3, wherein the electron emission electrode is disposed in parallel with the plurality of ion extraction electrodes, and the through holes formed through the plurality of ion extraction electrodes and the electron emission electrode are arranged to correspond to each other.

8. An etching apparatus to etch a target object in a chamber unit, comprising:
a plurality of first electrodes to extract an ion beam from plasma generated in the chamber unit;
a second electrode having a surface coated with an electron emission layer, to convert the extracted ion beam into the neutral beam by a collision of the ion beam with electrons;
a third electrode provided between the plurality of first electrodes and the second electrode to control an emission amount of the electrons; and
a chuck to fix and support the target object to be etched by the neutral beam.

9. The etching apparatus according to claim 8, wherein the electron emission layer comprises a carbon nano-tube layer.

10. The etching apparatus according to claim 9, wherein the surface of the second electrode is coated with the electron emission layer to emit the electrons in a direction opposite to a traveling direction of the extracted ion beam.

11. The etching apparatus according to claim 10, wherein the electrons are emitted according to an electric potential difference between the second electrode and the third electrode.

12. The etching apparatus according to claim 8, further comprising a plurality of through holes formed through the second electrode and the third electrode, wherein a diameter of each of the through holes formed through the second electrode is equal to or larger than a diameter of each of the through holes formed through the third electrodes.

13. The etching apparatus according to claim 8, wherein the plurality of first electrodes, the second electrode, and the third electrode are spaced from each other by regular intervals, and are disposed in parallel.

14. An etching apparatus divided into a source chamber and a process chamber to etch a target object using an ion beam from plasma generated in the source chamber, comprising:
a grid of ion extraction electrodes to extract the ion beam and to control characteristics of the ion beam; and
an electron emission electrode to divide the source chamber and the process chamber to convert the ion beam extracted by the grid of ion extraction electrodes into a neutral beam, and including a plurality of through holes.

15. The etching apparatus according to claim 14, wherein the grid of ion extraction electrodes comprises:
a first row of electrodes to extract and accelerate an ion beam;
a second row of electrodes to decelerate the ion beam; and
a third row of electrodes to concentrate the ion beam.

16. The etching apparatus according to claim 15, wherein the electrodes are disposed in an ion extraction direction.

17. The etching apparatus according to claim 15, wherein each of the electrodes on each of the first row, second row, and third row, includes a plurality of coinciding through holes.

18. The etching apparatus according to claim 14, wherein the electron emission electrode emits electrons such that the electrons collide with the ion beam extracted by the grid of ion extraction electrodes to convert the ion beam into a neutral beam.

19. The etching apparatus according to claim 18, wherein the electron emission electrode emits electrons to the traveling ion beam such that the electrons uniformly collide with the ion beam.

20. The etching apparatus according to claim 18, wherein the electron emission electrode is a cool cathode, which can emit electrons with a small voltage without increasing in temperature.

21. The etching apparatus according to claim 14, wherein the electron emission electrode is disposed in parallel with the grid of ion extraction electrodes.

22. The etching apparatus according to claim 14, wherein the electron emission electrode comprises an electron emission layer to facilitate emission of electrons.

23. A method of an etching apparatus to etch a target object in a chamber unit, the method comprising:
extracting an ion beam from plasma generated in the chamber unit;
converting the extracted ion beam into a neutral beam by a collision of the ion beam with electrons; and
fixing and supporting the target object to be etched by the neutral beam.

24. A method of an etching apparatus to etch a target object in a chamber unit, the method comprising:
extracting the ion beam from the plasma generated in the chamber unit;
converting the extracted ion beam into the neutral beam by a collision of the ion beam with electrons;
controlling an emission amount of the electrons; and
fixing and supporting the target object to be etched by the neutral beam.

25. A method of an etching apparatus to etch a target object in a chamber unit, the method comprising:
extracting the ion beam;
controlling characteristics of the ion beam; and
converting the extracted ion beam into a neutral beam by emitting electrons such that the electrons collide with the ion beam.
